(19) United States
(12) Patent Application Publication
(10) Pub. No.: US 2013/0311235 A1
(43) Pub. Date: Nov. 21, 2013

(54) METHOD AND SYSTEM FOR ASSESSING BUSINESS-TO-BUSINESS SALES AND MARKETING PERFORMANCE DATA

(71) Applicant: SIRIUSDECISIONS, INC., Wilton, CT (US)

(72) Inventors: Anthony Jaros, Brookfield, CT (US); John Neeson, Ridgefield, CT (US); Richard Eldh, Westport, CT (US)

(73) Assignee: SiriusDecisions, Inc., Wilton, CT (US)

(21) Appl. No.: 13/894,701

(22) Filed: May 15, 2013

Related U.S. Application Data
(60) Provisional application No. 61/648,220, filed on May 17, 2012.

(51) Int. Cl. G06Q 10/06

(52) U.S. Cl. CPC G06Q 10/0639
USPC 705/7.31

(57) ABSTRACT

A computer-implemented system for assessing performance data is configured to execute software instructions for generating graphical user interfaces that relate to measurement indicators. The measurement indicators pertain to a demand creation model comprising a marketing automation platform and a sales force automation platform. A method for assessing performance data using such a system includes the steps of defining a marketing automation platform and a sales force automation platform; qualifying a plurality of leads from the marketing automation platform; transferring the qualified leads from the marketing automation platform to the sales force automation platform; qualifying at least a portion of the qualified leads transferred from the marketing automation platform to the sales force automation platform; and calculating a rate of conversion based on the qualified leads from the marketing automation platform and the qualified leads from the sales force automation platform.

The present application claims the benefit of U.S. provisional application No. 61/648,220 filed on May 17, 2012, which is incorporated herein by reference in its entirety and for all purposes.

### TECHNICAL FIELD

The present invention relates to the assessment of performance data in the field of business-to-business sales and marketing. More specifically, the present invention relates to computer-implemented methods and systems for assessing performance data relating to an organization's ability create systematic, predictable and measurable demand.

### BACKGROUND OF THE INVENTION

In the marketing and sales of business-to-business products and solutions, large amounts of performance data and associated analyses are generated and contributed by various functions. The success of the contributions made by these functions can be distilled down to identifiable demand creation-related measurement indicators. These measurement indicators are regularly reported to management, quantified, and used to gauge a component of performance in order to assess the extent to which tactical and strategic marketing plans, as well as teleprospecting and field sales prospecting efforts have contributed to an organization's pipeline and topline revenue creation.

The identifiable demand creation-related measurement indicators previously used include inquiries (raw responses generated by marketing), marketing qualified leads developed from the inquiries and qualified to a level agreed to by marketing and sales, accepted sales leads from marketing qualified leads, qualified sales leads developed from the interaction of a salesperson with the lead, and closed/won deals. In a system utilizing such measurement indicators, marketing is partnered with teleprospecting and sales to increase the likelihood that efforts made to market an offering are not ineffectively utilized by a sales force not willing to work the demand.

The methods and systems of the present invention improve upon the foregoing and provide advantages over the methods and systems previously used.

### SUMMARY OF THE INVENTION

The present invention relates to the assessment of performance data in the field of business-to-business sales and marketing. More specifically, the present invention relates to computer-implemented methods and systems for assessing performance data relating to an organization's ability create systematic, predictable and measurable demand.

In one example embodiment of a computerized method for assessing sales and marketing performance data in accordance with the present invention, a marketing automation platform is defined for receiving, analyzing, nurturing, and qualifying marketing leads and a sales force automation platform is defined for receiving qualified marketing leads from the marketing automation platform, receiving sales generated leads, analyzing the qualified marketing leads and sales generated leads, determining qualified sales leads from the analyzing of the qualified marketing leads and sales generated leads, and determining performance metrics of marketing efforts. At least a portion of the marketing leads received by the marketing automation platform are qualified based on objective criteria to determine whether the marketing lead is viable. The qualified marketing leads are then transferred to the sales force automation platform. At least a portion of the qualified marketing leads and sales generated leads are qualified as qualified sales leads by the sales force automation platform based on objective criteria to determine whether a sales opportunity exists with respect to each of the qualified marketing leads and sales generated leads. At least one rate of conversion is calculated based on at least a number of qualified marketing leads from the marketing automation platform and a number of qualified sales leads from the sales force automation platform.

The sales generated leads may be provided to the sales force automation platform directly via a sales function which accepts user inputs from a sales team.

The sales generated leads may be combined with the qualified marketing leads for an overall determination of a total amount of the qualified sales leads.

The method may further comprise providing a user initiated marketing function which includes a teleprospecting function. The marketing function enables user interaction with the marketing automation platform. The teleprospecting function enables user generation of marketing leads and user nurturing of marketing leads that are not qualified by the marketing automation platform.

The method may further comprise providing a user initiated sales function. The sales function enables user interaction with the sales force automation platform and user generation of sales leads.

The qualifying of the marketing leads may comprise nurturing a marketing lead to an extent that indicates that the marketing lead is viable. The nurturing may comprise engaging the marketing leads by providing or obtaining information in order to enhance an opportunity to close business related to said marketing lead. The nurturing may comprise at least one of system-led and human-led communications. For example, the nurturing may comprise communication with a source of said lead comprising at least one of telephone calls, emails, direct mail, and the like to obtain or provide lead-related information.

The portion of leads received by the marketing automation platform may comprise a plurality of inbound inquiries and outbound inquiries. The inbound inquires may comprise requests to receive information and the outbound inquiries may comprise offers to provide information.

The qualified marketing leads provided by the marketing automation platform to the sales force automation platform is an aggregate of qualified marketing leads comprising a plurality of automation qualified marketing leads, a plurality of teleprospecting accepted marketing leads, and a plurality of teleprospecting generated marketing leads. The teleprospecting accepted marketing leads comprises a portion of the automation qualified leads.

A marketing service-level agreement specifies selection criteria for selecting said teleprospecting accepted leads from the automation qualified leads. A sales service-level agreement specifies selection criteria for selecting a plurality of qualified marketing leads from said marketing automation platform.

Once a qualified marketing lead or a sales generated lead is qualified as a qualified sales lead, the method may further comprise assigning a value coinciding with an anticipated monetary expenditure and assigning an anticipated sale date.

The marketing leads that do not become qualified marketing leads may be subjected to further nurturing.

The at least one rate of conversion may be used to determine anticipated sales based on a specified inquiry volume. Attributes that effect the at least one rate of conversion may comprise at least one of size of an organization, price point for sale of goods or services subject to the marketing lead, geographical maturity of a brand related to the goods or services, and the like.

The marketing automation platform and the sales force automation platform may be implemented as a computerized waterfall model.

In one example embodiment, a route-around may be provided enabling marketing leads that are determined to initially meet predetermined qualification criteria are provided directly from an automation qualified lead stage of the marketing automation platform to a sales accepted lead stage of the sales force automation platform. The predetermined qualification criteria comprises at least one of a predetermined qualification score (e.g., one that is particularly high), a determination that the marketing lead is from a strategic account, a determination that the originator of the marketing lead desires to speak with a sales representative, or the like.

The present invention also encompasses a computerized system for assessing sales and marketing performance data. An example embodiment of such a system comprises a computerized waterfall model comprising a marketing automation platform for receiving, analyzing, nurturing, and qualifying marketing leads and a sales force automation platform for receiving qualified marketing leads from the marketing automation platform, receiving sales generated leads, analyzing the qualified marketing leads and sales generated leads, determining qualified sales leads from the analyzing of the qualified marketing leads and sales generated leads, and determining performance metrics of sales and marketing efforts. A computer with memory is provided which is in communication with the waterfall model. A database is provided which is in communication with the computer. A user interface is provided which is in communication with the computer. The computer, in connection with the database and waterfall model is adapted to: qualify at least a portion of said marketing leads received by said marketing automation platform based on objective criteria to determine whether the marketing lead is viable; transfer the qualified marketing leads to said sales force automation platform; qualify at least a portion of the qualified marketing leads and sales generated leads as qualified sales leads by the sales force automation platform based on objective criteria to determine whether a sales opportunity exists with respect to each of the qualified marketing leads and sales generated leads; and calculate at least one rate of conversion based on at least a number of qualified marketing leads from said marketing automation platform and a number of qualified sales leads from said sales force automation platform.

The system is also adapted to carry out the various features of the method embodiments discussed above.

### BRIEF DESCRIPTION OF THE DRAWINGS

The present invention will hereinafter be described in conjunction with the appended drawing figures, wherein like reference numerals denote like elements, and:

FIG. 1 is a block diagram of a computer-implemented waterfall model system for assessing performance data using measurement indicators that are related to demand creation.

FIG. 2 is a block diagram of a relationship between the waterfall model system and a computer on which the waterfall model system is implemented.

FIG. 3 is a flow diagram showing relationships between stages of the waterfall model system.

FIG. 4 is a flow diagram of a portion of a marketing qualification stage of the waterfall model system.

FIG. 5 is a flow diagram of a relationship between the marketing qualification stage and a sales qualification stage of the waterfall model system.

FIG. 6 is a flow diagram of a portion of the sales qualification stage.

### DETAILED DESCRIPTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

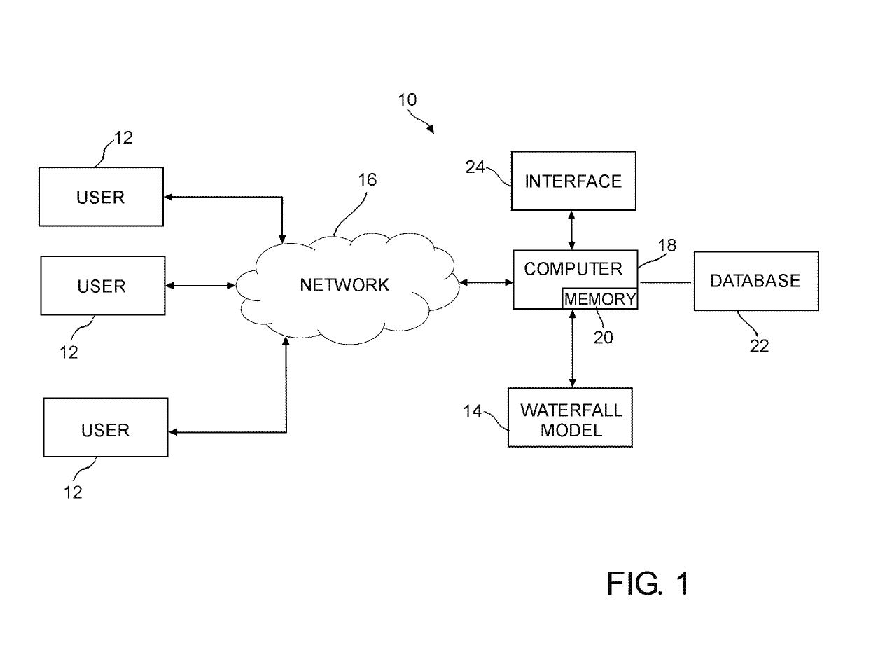

As shown in FIG. 1, a computer-implemented system for assessing sales and marketing performance data using demand creation-related measurement indicators with a waterfall model is shown generally at 10 and is hereinafter referred to as “system 10.” In system 10, users 12 interact with the waterfall model, which is shown at 14, and manipulate various measurement indicators related to demand creation. The users 12, which may include marketing and sales personnel, interact with the waterfall model 14 via a user interface and a network 16 hosted by a computer 18 having a memory 20 (e.g., random access memory) and/or being in communication with a database storage unit 22. The user interface can comprise, for example, a keyboard and display, a touch screen, or any other suitable interface well known in the art. The computer 18 also includes an interface 24 for direct interaction by an administrator. The computer 18 is operable via software configured to execute instructions for generating graphical interfaces that can be acted upon by the users 12. In using the system 10 through the computer 18, the effects of marketing efforts on sales results can be measured and a particular level of marketing efforts needed to achieve a desired amount of sales can be determined.

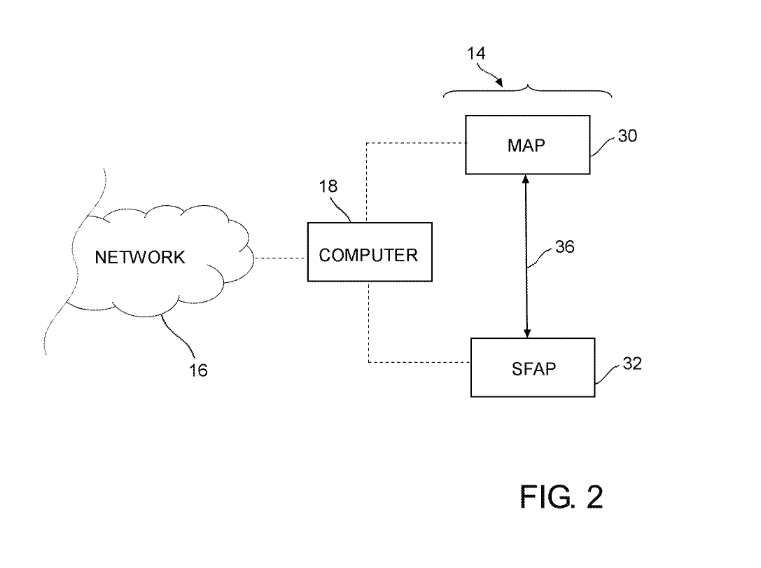

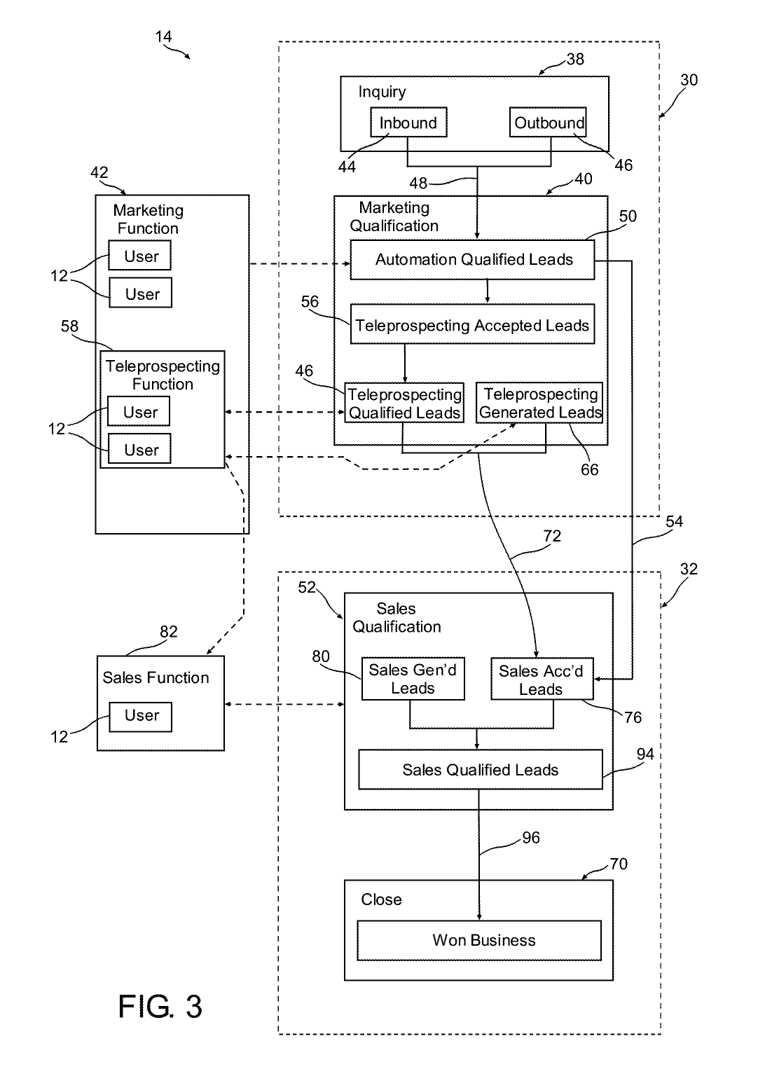

As shown in FIG. 2, the waterfall model 14 is defined by a marketing automation platform 30 (MAP 30) and a sales force automation platform 32 (SFAP 32) and is implemented on the computer 18. The MAP 30 and the SFAP 32 define several phases (shown in FIG. 3) that become generally successively narrower and increasingly focused as the waterfall model 14 progresses from an inquiry phase in which initial contact is made with a prospect (either through outbound or inbound means) to a phase in which business (e.g., a sale) is closed. Although the MAP 30 and the SFAP 32 are illustrated as being separate entities and in communication with each other via a bi-directional communication line 36, the present invention is not limited in this regard, as the MAP 30 and the SFAP 32 may be integral with each other and comprise a single unit.

As will be explained in more detail below, the MAP 30 is configured for receiving, analyzing, nurturing, and qualifying marketing leads and the SFAP 32 is configured for receiving the qualified marketing leads from the MAP 30, receiving sales generated leads, analyzing the qualified marketing leads and sales generated leads, determining qualified sales leads from the analyzing of the qualified marketing leads and sales generated leads, and determining performance metrics of marketing, sales and teleprospecting efforts. At least a portion of the marketing leads received by the MAP 30 are qualified based on objective criteria to determine whether the marketing lead is viable. The qualified marketing leads are then transferred to the SFAP 32. At least a portion of the qualified marketing leads and sales generated leads are qualified as qualified sales leads by the SFAP 32 based on objective criteria to determine whether a sales opportunity exists with respect to each of the qualified marketing leads and sales generated leads. At least one rate of conversion is calculated based on at least a number of qualified marketing leads from the MAP 30 and a number of qualified sales leads from the SFAP 32.

As used herein, the term “marketing lead” is meant to denote any lead that is received by or acted on in the MAP 30. The term “sales lead” is meant to denote any lead that is received by or acted on in the SFAP 32. Further, it should be appreciated that what constitutes a lead and an opportunity differs vastly in different scenarios (e.g. demand type, region, business unit, and the like). Therefore, the criteria used to qualify the leads may vary as well. For example, a lead may be deemed qualified in the MAP 30 when a prospect takes a particular set of actions (e.g. downloading a white paper, attending an online or offline event, or the like). In another scenario, the prospect may be deemed qualified in the SFAP 32 when he or she indicates that budget has been allocated to make a specific purchase, and there is an anticipated timeframe to make said purchase.

As shown in FIG. 3, the MAP 30 comprises an inquiry phase 38 and a marketing qualification phase 40 and is operated by users 12 in connection with a user initiated marketing function 42 and a teleprospecting function 58. The teleprospecting function 58 may be a subset of the marketing function 42. The marketing function 42 enables user interaction with the MAP 30. The teleprospecting function 58 enables user generation of marketing leads and user nurturing of marketing leads that are not qualified by the MAP 30. In the inquiry phase 38, both inbound inquiries 44 (requests to receive information) and outbound inquiries 46 (offers to provide information) are derived from marketing-led activities and are employed by the marketing function 42 to denote the beginning of a buying/selling process based on demand. For example, inbound marketing inquiries 44 may be requests to receive information in response to marketing activity including but not limited to search engine marketing, social media, content syndication, and other typical marketing activity. Further, outbound inquiries 46 may include offers to provide information, including but not limited to such offers sent via email, direct mail, or the like. To ascertain the beginning of a prospect or lead from an inbound inquiry 44, communication from the inbound inquiry 44 is tracked and logged for future reference. To ascertain the beginning of a prospect or lead from an outbound inquiry 46, communications to the inquiry are tracked and logged. As inbound inquiries 44 are proactive efforts made on the part of prospects or leads to receive information, the conversion rates thereof to automation qualified leads are generally higher than the conversion rates of outbound inquiries 46 to automation qualified leads.

Once an inquiry has been classified as an inbound inquiry 44 or an outbound inquiry 46, either system-led nurturing (for example, in the form of email communication in response to the inquiry) or human-led nurturing (telephone follow-up) is initiated. It should be appreciated that the nurturing may comprise any type of communication with a source of said lead, including but not limited to telephone calls, emails, direct mail and the like to obtain or provide lead-related information. As used herein, the term “nurturing” means engaging prospects or leads by interacting with the prospect or lead by providing or obtaining valuable information in an effort to gain a position as a desirable choice for further business and for closing of that business. The nurturing may be rudimentary, such as a simple review by a teleprospector to ensure that a match exists against a desired demographic profile. In most instances, however, the nurturing includes additional interactions with the lead and an assessment at a baseline level as to the viability of the lead being convertible into an opportunity for sales. The inquiry is then directed to the marketing qualification phase 40 via an inquiry stream 48.

The marketing qualification phase 40 receives the inquiry stream 48 comprising the inbound inquiries 44 and/or the outbound inquiries 46. The marketing qualification phase 40 classifies each inquiry as an automation qualified lead 50 (AQL 50), which is a lead that meets certain criteria as having potential to qualify as future closed business. Once an inquiry (either an inbound inquiry 44 or an outbound inquiry 46) is classified as an AQL 50, the inquiry is subjected to nurturing via teleprospecting in which a user 12 of the teleprospecting function 58 actively contacts a source of the lead via telephone or email.

In some instances when an inquiry is classified as an AQL 50, the AQL 50 is delivered directly to a sales qualification phase 52 via a route-around 54, thereby being directly delivered to the field or channel (such as a sales representative or partner) as a sales accepted lead (described below). Delivery of the AQL 50 directly to the sales qualification phase 52 via the route-around 54 may occur as a result of a lead demonstrating an extraordinarily high score, a lead being from a specifically-named or strategic account, or leads explicitly indicating the desire to speak with a sales representative, or the like.

If the AQL 50 is not sent to the sales qualification phase 52 via the route-around 54, the AQL 50 is handed off from the AQL 50 and is further classified as a teleprospecting accepted lead 56 (TAL 56). Thus, the TALs 56 comprise at least a portion of the AQLs 50. In classifying AQL 50 as a TAL 56, the system 10 indicates (e.g., via an email or other communication) that the lead is prepared for further qualification by a telequalifying agent.

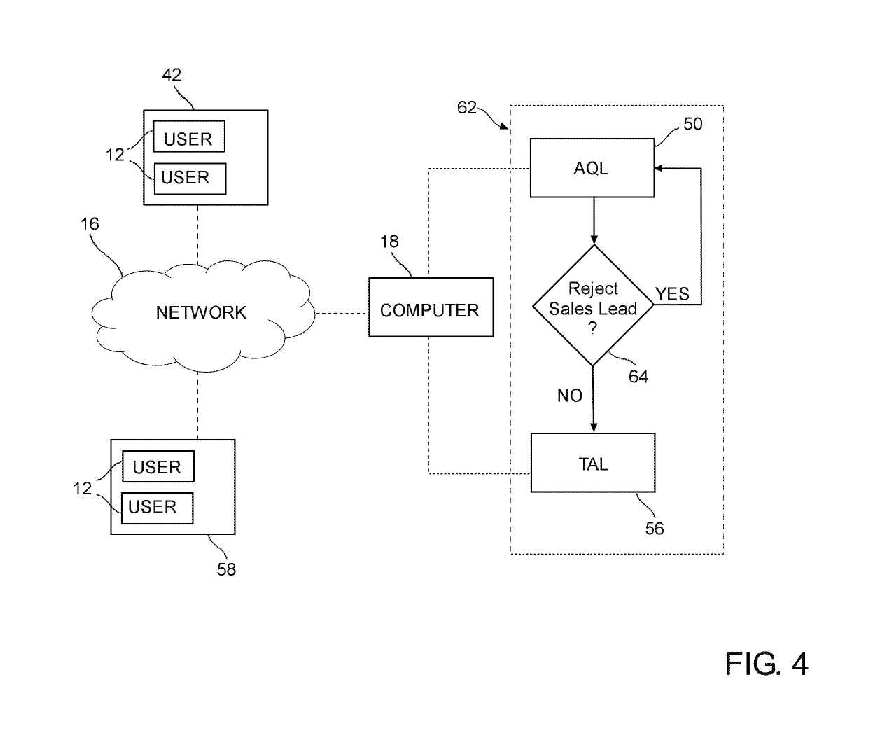

As shown in FIG. 4, an initial transfer of a lead occurring between a user 12 of the marketing function 42 and a user 12 of the teleprospecting function 58 via a transfer route from the AQL 50 to the TAL 56 is shown generally at 62. The transfer route 62 is a subroutine of the waterfall model 14. In an initial transfer of a lead via the transfer route 62, the teleprospecting function 58 operates to generate and qualify the leads by continuously identifying prospects, for example, by telephone contact. The transfer of the lead via the transfer route 62 is governed by a marketing service-level agreement 64 in which a user 12 of the teleprospecting function 58 accepts the lead from the AQL 50 (and begins working thereon) or rejects the sales lead within a given timeframe. Reasons for rejecting the lead at this point are procedural in nature (e.g., inaccurate and/or incomplete contact information, existing opportunity, incorrectly routed sales lead, and the like). The reasons, however, are conveyed through the network 16 to the marketing function 42 and are understood by the marketing function 42. Rejected leads may be returned to marketing to address the reasons for rejection.

The initial transfer of a sales lead between the marketing function 42 and the teleprospecting function 58 generally occurs through the network 16 to allow for the authorization of acceptance (or rejection) of the lead from the AQL 50 and the notification of such authorization to the marketing function 42.

Referring back to FIG. 3, the marketing qualification phase 40 further includes a stage comprising teleprospecting qualified leads 46 (TQL 46) derived from marketing-led activities. In the TQL 46 stage, leads derived from the TAL 56 are accepted by users 12 of the teleprospecting function 58. After accepting the TQL 46 from the TAL 56, the teleprospecting function 58 begins a process of outreach that involves making contact by with a source of the leads by initiating telephone calls, emails, direct mail, or the like. Such contact facilitates the gathering of incremental information about a lead (e.g., available budget, timeframes for purchases, timeframes for delivery, and the like) and potentially gets the lead to commit to a further encounter in the form of a face-to-face or telephone appointment with a field sales representative or channel partner.

The marketing qualification phase 40 further includes teleprospecting generated leads 66 (TGLs 66), which include demand developed exclusively by the teleprospecting function 58. The teleprospecting function 58, when not qualifying leads that have originated in the MAP 30, can develop the TGLs 66 by running small-net fishing efforts to source new prospects and leads not derived from the marketing function 42, or do so via cold calling. The small-net fishing efforts can include segmentation of prospects into various groups, the pulling of prospect names from various lists, the writing of scripts for use in contacting prospects, and the like. Adding these incremental prospects and leads to the number of TQLs 46 (along with the route around 54) indicates the total amount of lead volume that is being transferred to the sales force automation platform 32.

With regard to organizations that sell products that are transactional in nature (as opposed to goods-based), substantial marketing qualification may be deemed to be neither necessary nor cost effective. Accordingly, the marketing qualification phase 40 may be reduced in scope when implemented in a transactional or service-based environment.

Still referring to FIG. 3, the SFAP 32 comprises the sales qualification phase 52 and a close phase 70. A marketing outlet stream 72 is handed off from the marketing qualification phase 40 and directed to the sales qualification phase 52. In the sales qualification phase 52, activities conducted by sales representatives or partners are analyzed and rated to ascertain whether leads generated by the marketing function 42 and the teleprospecting function 58 are viable.

The marketing outlet stream 72, which is exclusive of the route-around 54 and is defined by a combination of leads from the TQLs 46 and the TGLs 66 (which include leads from AQL 50 and TAL 56), contributes to sales accepted leads 76 (SALs 76). The SALs 76 also include the leads transferred directly from the automation qualified lead stage 50 via the route-around 54. The SALs 76 are similar to the TALs 56 described above with regard to the marketing qualification phase 40; however, in the sales qualification phase 52 a transfer is made between the teleprospecting function 58 of the MAP 30 and a sales representative or partner of the SFAP 32 as opposed to the transfer of a lead or prospect occurring between the marketing function 42 and the teleprospecting function 58 within the marketing qualification phase 40 of the MAP 30.

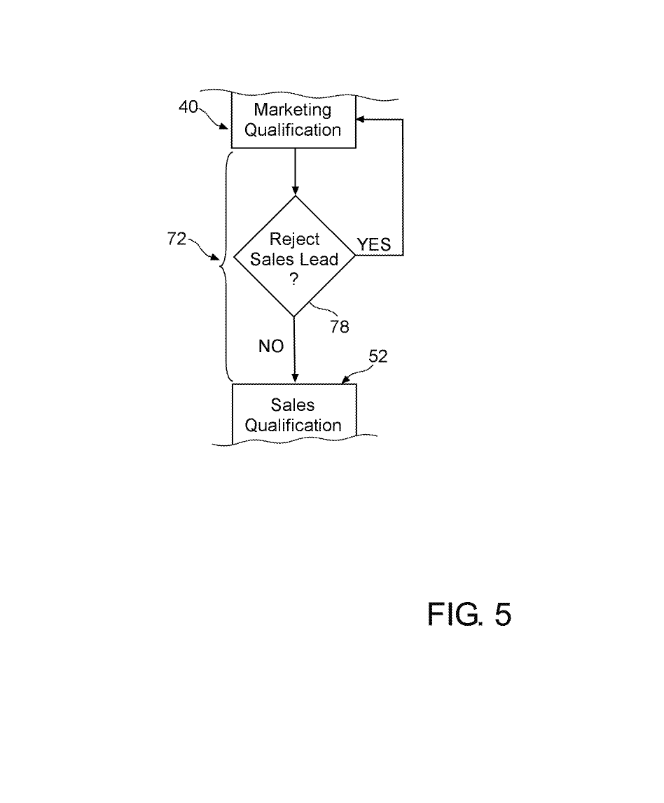

As shown in FIG. 5, prior to the marketing outlet stream 72 being received in the sales qualification phase 52, a service-level agreement 78 can be utilized to require that a sales resource either accepts or rejects the lead in a certain timeframe, with rejection occurring for reasons that are procedural in nature (e.g., inaccurate and/or incomplete contact information, existing opportunity, incorrectly routed sales lead, and the like). Rejected leads may be automatically rerouted back to the MAP 30 for further nurturing, requalification, and/or resubmission to the sales qualification phase 52.

Referring back to FIG. 3, sales generated leads 80 (SGLs 80) may also be developed as a new stage in the sales qualification phase 52. The SGLs 80 are new sales leads that are developed by a user initiated sales function 82 that includes one or more sales teams comprising sales representatives or partners thereof (e.g., users 12). The sales function 82 enables user interaction with the SFAP 32 and user generation of sales leads. The SGLs 80 are provided directly to the SFAP 32 via the sales function 82 and are derived from demand created by direct sales or channel resources such as networking, cold calling, and the like. The combination of SGLs 80 and SALs 76 indicates the total number of sales leads that the sales function 82 is attempting to advance through the sales process. Measured over time, the sales qualification phase 52 allows a user of the system 10 (and particularly the waterfall model 14) to determine how demand that is sourced by the marketing function 42 and/or the teleprospecting function 58 performs compared to demand sourced by the sales function 82. In analyzing the system 10 based on the sales qualification phase 52, differences in performance can be diagnosed and addressed.

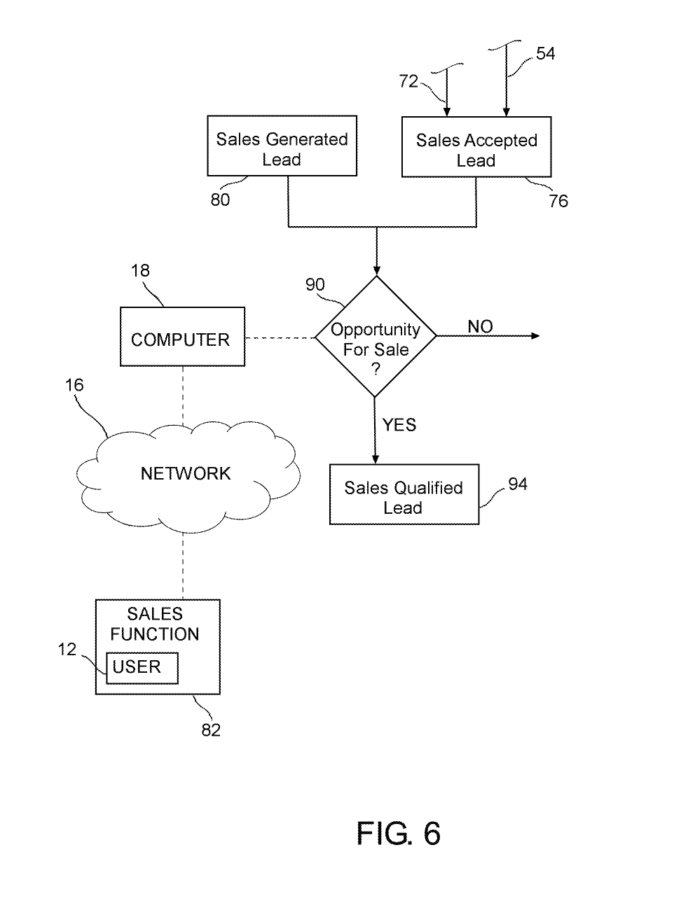

As shown in FIG. 6, after one or more interactions (which may be via telephone, email, direct mail, in-person conversations, or the like) between a user 12 of the sales function 82 and the leads, the sales function 82 makes a determination using objective criteria 90 (information from the lead) as to whether an opportunity for a sale exists based on the SALs 76 and SGLs 80. If it is determined that an opportunity for a sale exists, the opportunity is classified as a sales qualified lead 94 (SQL 94). The SQL 94 is assigned a starting anticipated dollar value factored e.g., at about 5% to about 10% for forecasting purposes. The SQL 94 is further assigned a sale or close date (the date is dependent on the organization's average sales cycle length). If it is determined by the objective criteria 90 that there is not an opportunity for a sale to exist, then the SQL 94 is disqualified, and returned back to either the marketing function 42 or the teleprospecting function 58 for further nurturing.

Referring back to FIG. 3, a sales stream 96 is received from the SQL 94 and directed to the closing phase 70. In the closing phase 70, a final conversion ratio of leads to closed/won deals is determined. The final conversion ratio may comprise a measurement of the conversion rates of each sales team comprising the sales function 82.

Referring now to all the Figures, the AQLs 50, SALs 76, TQLs 46, TGLs 66, and SGLs 80 are defined as performance indicators created by demand. Using these performance indicators, rates of conversion of the AQLs 50, TQLs 46, TGLs 66, and SALs 76, SGLs 80 to SQLs 94 can each be determined. When such rates of conversion are known, data can be used with the waterfall model 14 to anticipate sales based on inquiry volume. The data can also be used to determine the amount of inquiry expected to produce a desired amount of sales. Factors considered in assessing whether a suitable contribution results in an SQL 94 include, but are not limited to, organization size, the price point of the goods being sold, geographical maturity (for example, the extent of brand recognition with regard to competing goods), and the like.

The present invention can also be used to make comparisons between marketing and sales functions. Additionally, the marketing and sales effectiveness of one organization relative to another organization can be assessed. In particular, the waterfall model 14 can also be used to provide the following:

### Inquiry to Marketing

All Inquiries to AQL: The percentage of inquiries, regardless of source, that are deemed by

AQL 50 to be worthy of further qualification.
% of Inquires from Inbound: The total percentage of inquiries which were generated by inbound mechanisms.
AQL to TAL: The percentage of leads qualified via AQL 50 that have been passed to and formally accepted by the teleprospecting function 56.
TAL to TQL: The percentage of leads formally accepted by the teleprospecting function 56 that are deemed qualified for a receiving function (e.g. field rep, channel partner) in the marketing function 42 to work.

### Marketing to Sales

TQL to SAL: The percentage of leads qualified by the teleprospecting qualified leads function 46 that have been passed to and formally accepted by the sales accepted leads function 76.
TGL to SAL: The percentage of leads sourced and qualified by the teleprospecting generated leads function 66 that have been passed to and formally accepted by the sales accepted leads function 76.
AQL to SAL: The percentage of leads qualified via AQL 50 that have been passed directly to and formally accepted by the sales accepted leads function 76.
SAL to SQL: The percentage of leads accepted by the sales accepted leads function 76 that have been qualified and promoted to an opportunity—complete with estimated revenue and timeframe to close—by the sales qualified leads function 94.
SGL to SQL: The percentage of leads sourced and qualified directly by a sales rep or channel partner (SGL 80) that have been promoted to an opportunity—complete with estimated revenue and timeframe to close—by the sales qualified leads function 94.
% of Total SAL from TGL: The total percentage of sales accepted leads (SAL 76), which were generated by telemarketing (TGL 66).
% of Total SQL from SGL: The total percentage of sales qualified leads (SQL 94), which were generated by sales (SGL 80).

### Sales to Close

SQL to Won Business: The percentage of opportunities (SQLs 94) that have converted to won business 70.
Amount and percent of Sales qualified leads 94 and won business 70 by source: Specification of the number and percentage of sales qualified leads and won business by: sales generated, sales accepted from TQL, sales accepted from TGL, sales accepted from AQL, and sales accepted from blended leads.
Average Deal Size: The average revenue generated from a closed opportunity

A reverse waterfall model is also contemplated, which comprises a structured approach to quantify the number of inquires a marketing organization must generate to achieve revenue objectives. The framework may be embodied in a calculator or computerized algorithm and is closely related to the waterfall model discussed above.

In one example embodiment of a reverse waterfall model, a user is requested to specify or input via a graphical user interface:

1. Annual New Bookings. The total revenue that the management team seeks to obtain in a specified time period, typically a financial year.
2. Marketing Contribution. The percentage of annual new bookings that marketing is expected to originate from leads that marketing sourced.
3. Pipeline Ratio Pipe X. The desired dollar size of the sales pipeline relative to the sales quota that sales leadership has specified to ensure that there is sufficient opportunity to hit the new business target.
4. Average Deal Size: The average revenue generated from a closed (net new) opportunity.
5. Inquires per individual. The approximate number of inquiries per individual.
6. MQL/Inquiry Conversion Rate. This is the number of Marketing Qualified Leads (MQL) divided by the number of inquiries.
7. SAL/MQL Conversion Rate. This is the number of Sales Accepted Leads (SAL) divided by the number of Marketing Qualified Leads (MQL).
8. SQL/SAL Conversion Rate. This is the conversion rate of Sales Qualified Leads (SQL) divided by the number of Sales Accepted Leads (SAL).
9. Close/SQL Conversion Rate. This is the conversion rate of Close Won opportunities divided by Sales Qualified Leads (SQL).
10. Demand creation budget. The budget the organization has specified for demand creation.

The tool may then present one or more of the following:

1. The number of net new bookings required from marketing and sales in order to achieve the organization's revenue target.
2. The number of total pipeline required from marketing and sales in order to achieve the organizations revenue target.
3. The number of total pipeline deals required from marketing and sales in order to achieve the organizations revenue target.
4. The number of close/won deals required from marketing and sales in order to achieve the organizations revenue target.
5. The number of sales qualified leads that will need to have been originated by marketing in order to achieve the organizations revenue target.
6. The number of sales accepted leads that will need to have been originated by marketing in order to achieve the organizations revenue target.
7. The number of marketing qualified leads that marketing will need to originate in order to achieve the organization's revenue target.
8. The number of inquiries that marketing will need to originate in order to achieve the organization's revenue target.
9. The number of unique individuals that will likely comprise the number of inquiries required.
10. The revenue and cost associated with an individual lead in the first stages of the demand creation waterfall (inquiry, MQL, SAL, SQL).

It should now be appreciated that the waterfall model 14 of the present invention provides advantageous methods and systems for tracking prospecting-sourced leads and sales-sourced leads so that differences in performance can be identified and upstream adjustments commissioned in an effort to improve overall sales, particularly with regard to business-to-business transfers. The present invention is not limited to business-to-business transactions, however, as the transfers may involve transactions between businesses and individuals or transactions between businesses and government.

Although the invention has been described in connection with various illustrated embodiments, numerous modifications and adaptations may be made thereto without departing from the spirit and scope of the invention as set forth in the claims.

What is claimed is:

1. A computerized method for assessing sales and marketing performance data, comprising:
defining a marketing automation platform for receiving, analyzing, nurturing, and qualifying marketing leads;
defining a sales force automation platform for receiving qualified marketing leads from the marketing automation platform, receiving sales generated leads, analyzing the qualified marketing leads and sales generated leads, determining qualified sales leads from the analyzing of the qualified marketing leads and sales generated leads, and determining performance metrics of sales and marketing efforts;
qualifying at least a portion of said marketing leads received by said marketing automation platform based on objective criteria to determine whether the marketing lead is viable;
transferring the qualified marketing leads to said sales force automation platform;
qualifying at least a portion of the qualified marketing leads and sales generated leads as qualified sales leads by the sales force automation platform based on objective criteria to determine whether a sales opportunity exists with respect to each of the qualified marketing leads and sales generated leads; and
calculating at least one rate of conversion based on at least a number of qualified marketing leads from said marketing automation platform and a number of qualified sales leads from said sales force automation platform.

2. The method of claim 1, wherein:
the sales generated leads are provided to the sales force automation platform directly via a sales function which accepts user inputs from a sales team.

3. The method of claim 1, further comprising:
combining the sales generated leads with the qualified marketing leads for a determination of a total amount of the qualified sales leads.

4. The method of claim 1, further comprising providing a user initiated marketing function which includes a teleprospecting function, wherein:
said marketing function enables user interaction with the marketing automation platform; and
said teleprospecting function enables user generation of marketing leads and user nurturing of marketing leads that are not qualified by the marketing automation platform.

5. The method of claim 1, further comprising providing a user initiated sales function, wherein:
said sales function enables user interaction with the sales force automation platform and user generation of sales leads.

6. The method of claim 1, wherein said qualifying of said marketing leads comprises nurturing a marketing lead to an extent that indicates that the marketing lead is viable.

7. The method of claim 6, wherein said nurturing comprises engaging said marketing leads by providing or obtaining information in order to enhance an opportunity to close business related to said marketing lead.

8. The method of claim 7, wherein said nurturing comprises at least one of system-led and human-led communications.

9. The method of claim 7, wherein nurturing comprises communication with a source of said lead comprising at least one of telephone calls, emails, and direct mail to obtain or provide lead-related information.

10. The method of claim 1, wherein:
said portion of leads received by said marketing automation platform comprises a plurality of inbound inquiries and outbound inquiries; and
the inbound inquires comprise requests to receive information and the outbound inquiries comprise offers to provide information.

11. The method of claim 1, wherein said qualified marketing leads provided by said marketing automation platform to said sales force automation platform is an aggregate of qualified marketing leads comprising a plurality of automation qualified marketing leads, a plurality of teleprospecting accepted marketing leads, and a plurality of teleprospecting generated marketing leads.

12. The method of claim 11, wherein said teleprospecting accepted marketing leads comprises a portion of said automation qualified leads.

13. The method of claim 12, wherein a marketing service-level agreement specifies selection criteria for selecting said teleprospecting accepted leads from the automation qualified leads.

14. The method of claim 1, wherein a sales service-level agreement specifies selection criteria for selecting a plurality of qualified marketing leads from said marketing automation platform.

15. The method of claim 1, wherein once a qualified marketing lead or a sales generated lead is qualified as a qualified sales lead, the method further comprises:
assigning a value coinciding with an anticipated monetary expenditure; and
assigning an anticipated sale date.

16. The method of claim 1, wherein the marketing leads that do not become qualified marketing leads are subjected to further nurturing.

17. The method of claim 1, wherein said at least one rate of conversion is used to determine anticipated sales based on a specified inquiry volume.

18. The method of claim 1, wherein attributes that effect said at least one rate of conversion comprise at least one of size of an organization, price point for sale of goods or services subject to the marketing lead, and geographical maturity of a brand related to the goods or services.

19. The method of claim 1, wherein said marketing automation platform and said sales force automation platform are implemented as a computerized waterfall model.

20. The method of claim 1, wherein:
a route-around is provided enabling marketing leads that are determined to initially meet predetermined qualification criteria are provided directly from an automation qualified lead stage of the marketing automation platform to a sales accepted lead stage of the sales force automation platform; and
the predetermined qualification criteria comprises at least one of a predetermined qualification score, a determination that the marketing lead is from a strategic account, a determination that the originator of the marketing lead desires to speak with a sales representative.

21. A computerized system for assessing sales and marketing performance data, comprising:
a computerized waterfall model comprising:
a marketing automation platform for receiving, analyzing, nurturing, and qualifying marketing leads; and
a sales force automation platform for receiving qualified marketing leads from the marketing automation platform, receiving sales generated leads, analyzing the qualified marketing leads and sales generated leads, determining qualified sales leads from the analyzing of the qualified marketing leads and sales generated leads, and determining performance metrics of sales and marketing efforts;
a computer with memory in communication with the waterfall model;
a database in communication with the computer; and
a user interface in communication with the computer;
wherein the computer, in connection with the database and waterfall model, is adapted to:
qualify at least a portion of said marketing leads received by said marketing automation platform based on objective criteria to determine whether the marketing lead is viable;
transfer the qualified marketing leads to said sales force automation platform;
qualify at least a portion of the qualified marketing leads and sales generated leads as qualified sales leads by the sales force automation platform based on objective criteria to determine whether a sales opportunity exists with respect to each of the qualified marketing leads and sales generated leads; and
calculate at least one rate of conversion based on at least a number of qualified marketing leads from said marketing automation platform and a number of qualified sales leads from said sales force automation platform.
